(19) United States
(12) Patent Application Publication
(10) Pub. No.: US 2014/0001887 A1
(43) Pub. Date: Jan. 2, 2014

(54) VIRTUAL POWER APPARATUS

(71) Applicant: VIRTUAL POWER SYSTEMS, INC., Saratoga, CA (US)

(72) Inventors: Shankar Ramamurthy, Saratoga, CA (US); Madhav Manjrekar, Cary, NC (US); Steven Uhlir, Los Altos, CA (US)

(73) Assignee: Virtual Power Systems Inc., Saratoga, CA (US)

(21) Appl. No.: 13/735,991

(22) Filed: Jan. 7, 2013

Related U.S. Application Data
(60) Provisional application No. 61/665,007, filed on Jun. 27, 2012.

(51) Int. Cl. H02J 4/00

(52) U.S. Cl. CPC H02J 4/00
USPC 307/151

(57) ABSTRACT

A system for at least one virtual power apparatus includes a first virtual power apparatus that includes a first port configured to receive a first power signal, a second port configured to provide a second power signal, and a power system controller communicatively connected to a power device. The power system controller is configured to receive an image of an electric power solution, wherein the image comprises instructions for deriving the second power signal by altering and routing the first power signal, process the image by converting the image instructions into commands understandable by the power device, and send the commands to the power device for realizing the image in the power device. The power device is configured to receive the command for realizing the image, derive the second power signal, and provide the second power signal to the second port.

### CROSS-REFERENCE TO RELATED APPLICATIONS

The present application claims priority from Provisional Patent Application No. 61/665,007, filed Jun. 27, 2012. The content of the priority application is hereby incorporated by reference in its entirety.

### BACKGROUND OF INVENTION

1. Technical Field

This invention relates a virtual power apparatus for altering and routing a power signal from an electrical power source to an electrical power load.

2. Background Art

New products, technologies and services are being offered at an increasing pace in the areas of local energy generation, storage, appliances such as commercial and home-scale local electric energy generation through solar rooftop and small scale wind mills, bio digesters, fuel cells, electric-car quick battery chargers, and DC appliances like LEDs and DC motors. Even though systems in the form of building/home automation systems and control and monitoring for individual equipment and appliances are available, they monitor system wide but optimize energy and performance of individual equipment. As diversity of sources and sinks of energy supply increase, additional energy savings are possible if optimized at local system level that includes the myriad forms of supply—grid and local—and multiple local storage and local appliances.

A far more significant dynamic creates the opportunity for not only larger energy efficiency improvements but also one for less expensive, smarter, agile, and more flexible appliances and systems. Fast-developing economies, constituting a majority of today's humanity, demand more energy and appliances that use them. The pressure to increase energy efficiencies and cheaper and sustainable energy sources—‘subsidized’ or ‘ecology-tax-supported’ where necessary—is increasing. They also need inexpensive and capable appliances as energy becomes more available and affordable. Higher-end home and commercial users require all these too, but would emphasize the importance of smart, agile, and green appliances and systems. This demand will be met by innovations on the source, storage and usage side of not only the electric kind but other kinds as well.

It is known in the art that a “soft radio” is a piece of hardware that can be programmed to be any type of radio one could imagine, for example, an AM radio, FM radio, spread-spectrum radio, cell phone, HAM radio, and others. A similar ability exists among some computer hardware components where different components can be virtualized on a programmable processor. However, no such programmable systems exist for electrical power distribution.

For example, as shown in FIG. 1, currently electrical power systems are created and provided in a static fashion based on the power devices installed. Particularly, FIG. 1 discloses that the current state of the art is implemented by a power supply (102) being connected to powered systems (106) through a plurality of power devices (104) each of which provide different static functionality.

As shown in the upper diagram of FIG. 2, in an electrical power consuming facility (202), a universal power supply (UPS) (204) may be provided that does a static alternating current (AC) to direct current (DC) conversion, or vice-versa. Additionally, a power distribution unit (PDU) (206) may also be provided to do further power routing. Then within an electrical power consuming cabinet (208) found in the facility (202), another static AC to DC conversion (AC/DC), or a DC to DC conversion (DC/DC) may occur which is then again shaped and altered down to a proper voltage by other power devices, such as a point of load (POL) (210), until finally reaching a voltage regulator module (VRM) (212) which may be located on an associated motherboard within the cabinet (208).

### SUMMARY OF INVENTION

In general, in one aspect, one or more embodiments of the present invention relate to a system for at least one virtual power apparatus. The system may include a first virtual power apparatus of the plurality of virtual power apparatus. The first virtual power apparatus includes a first port configured to receive a first power signal, a second port configured to provide a second power signal, and a power system controller communicatively connected to a power device. The power system controller is configured to: receive an image of an electric power solution, wherein the image comprises instructions for deriving the second power signal by altering and routing the first power signal; process the image by converting the image instructions into commands understandable by the power device; send a command to the power device for realizing the image in the power device; and receive a status from the power device. The power device is communicatively connected to the power system controller and configured to receive the command for realizing the image, derive the second power signal by altering, based on the command, the first power signal, and routing, based on the command, the first power signal, provide the second power signal to the second port, and send the status to the power system controller.

In general, in one aspect, one or more embodiments of the present invention relate to a method for a virtual power apparatus. The method may include receiving, by a power system controller, an image of an electric power solution, wherein the image comprises instructions for deriving a second power signal by altering and routing a first power signal. The method may also include processing the image by converting the image instructions into commands understandable by the power device and sending, by the power system controller and to a power device, a command for realizing the image in the power device. Further, the method may include receiving, by the power system controller, a status from the power device or receiving status from devices connected to an input or output of the power device.

In general, in one aspect, one or more embodiments of the present invention relate to a virtual power apparatus (VPA). The VPA may include a first port configured to receive a first power signal, a second port configured to provide a second power signal, a power device communicatively connected to a power system controller. The power device may have the functionality to derive the second power signal from the first power signal, and provide the second power signal to the second port. The power system controller may be communicatively connected to the power device and configured to control the power device.

In general, in one aspect, one or more embodiments of the present invention relate to a non-transitory computer-readable medium storing a plurality of instructions for a virtual power apparatus. The plurality of instructions may include functionality to receive an image of an electric power solution, wherein the image comprises instructions for deriving a second power signal by altering and routing a first power signal, process the image by converting the image instructions into commands understandable by the power device, send a command for realizing the image in a power device, and receive a status from the power device.

Other aspects and advantages of the invention will be apparent from the following description and the appended claims.

### BRIEF DESCRIPTION OF DRAWINGS

FIG. 1 is a diagram depicting the flow of electrical power from supply to consumption.

FIG. 2 is an upper diagram of a power consuming location that includes a system for electrical power routing and altering between a grid supply and a computer motherboard, and a lower diagram of a similar power consuming location that implements a virtual power apparatus according to one or more embodiments of the present disclosure.

FIG. 3 is a block diagram of a virtual power apparatus according to one or more embodiments of the present disclosure.

FIG. 4 is a virtual power apparatus chassis according to one or more embodiments of the present disclosure.

FIG. 5 is a diagram of a virtual power apparatus with control logic according to one or more embodiments of the present disclosure.

FIGS. 6A and 6B are diagrams showing the communicative connection between power controllers and power devices according to one or more embodiments of the present disclosure.

FIGS. 7A-7F are functional diagrams that are representative of converting and routing in accordance with a virtual power apparatus according to one or more embodiments of the present disclosure.

FIG. 8 is a diagram depicting hardware and associated layers of software for controlling the hardware according to one or more embodiments of the present disclosure.

FIG. 9 is a plotting of hardware versus software implementation of a virtual power apparatus according to one or more embodiments of the present disclosure.

FIG. 10 is a depiction of software layers for a virtual power apparatus according to one or more embodiments of the present disclosure.

FIG. 11 is a diagram of a loop of virtual power apparatus according to one or more embodiments of the present disclosure.

FIG. 12 is a diagram of a control plane and an associated electric plane according to one or more embodiments of the present disclosure.

FIG. 13 is a diagram of server racks containing virtual power apparatus according to one or more embodiments of the present disclosure.

FIG. 14 is a diagram of server racks connected to and containing virtual power apparatus according to one or more embodiments of the present disclosure.

FIG. 15 is a block representation of the hardware and associated layers of software according to one or more embodiments of the present disclosure.

FIG. 16A is a depiction of a power grid arrangement showing the portions implemented by a virtual power apparatus according to one or more embodiments of the present disclosure.

FIG. 16B is a diagram of a power grid arrangement implementing a virtual power apparatus according to one or more embodiments of the present disclosure.

FIG. 16C is a diagram of a power grid arrangement implementing a virtual power apparatus according to one or more embodiments of the present disclosure.

FIG. 17 is a diagram of a power grid arrangement implementing virtual power apparatus according to one or more embodiments of the present disclosure.

FIG. 18 is a diagram of a power grid arrangement implementing a virtual power apparatus according to one or more embodiments of the present disclosure.

FIG. 19 is a landscape of information and control of power compared with power infrastructure according to one or more embodiments of the present disclosure.

FIG. 20 is a diagram of power considerations to be used to control a virtual power apparatus according to one or more embodiments of the present disclosure.

FIG. 21 is a diagram of power considerations to be used to control a virtual power apparatus according to one or more embodiments of the present disclosure.

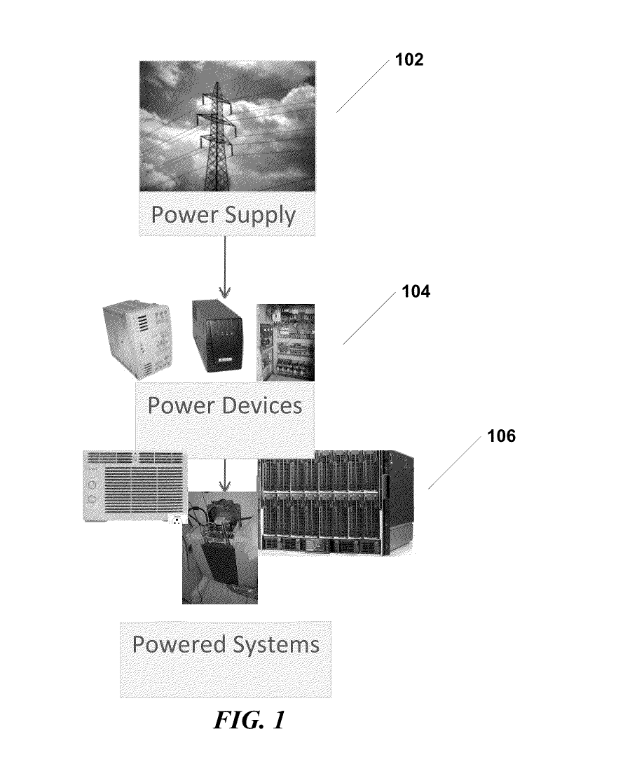

### DETAILED DESCRIPTION

In embodiments of the invention, numerous specific details are set forth in order to provide a more thorough understanding of the invention. However, it will be apparent to one with ordinary skill in the art that the invention may be practiced without these specific details. In other instances, well-known features have not been described in detail to avoid obscuring the invention.

One or more embodiments of the present disclosure relate generally to a virtual power apparatus that provides virtualized electrical power solutions to powered systems. Such virtualized power solutions may include power devices such as power supplies, switches, rectifier, and other electrical distribution devices.

According to one or more embodiments of the present disclosure, the electrical power solutions may be created as an image. This image is a set of instructions that can be provided to a virtual power apparatus which can take the image and execute the instructions by creating associated commands for a power device portion of a virtual power apparatus thereby taking an electrical power signal and altering and routing it as needed. Thus, a programmed image of an electric power solution or network is realized in a physical hardware implementation, known as a virtual power apparatus, which delivers electricity of the appropriate characteristics from the selected sources to the selected loads.

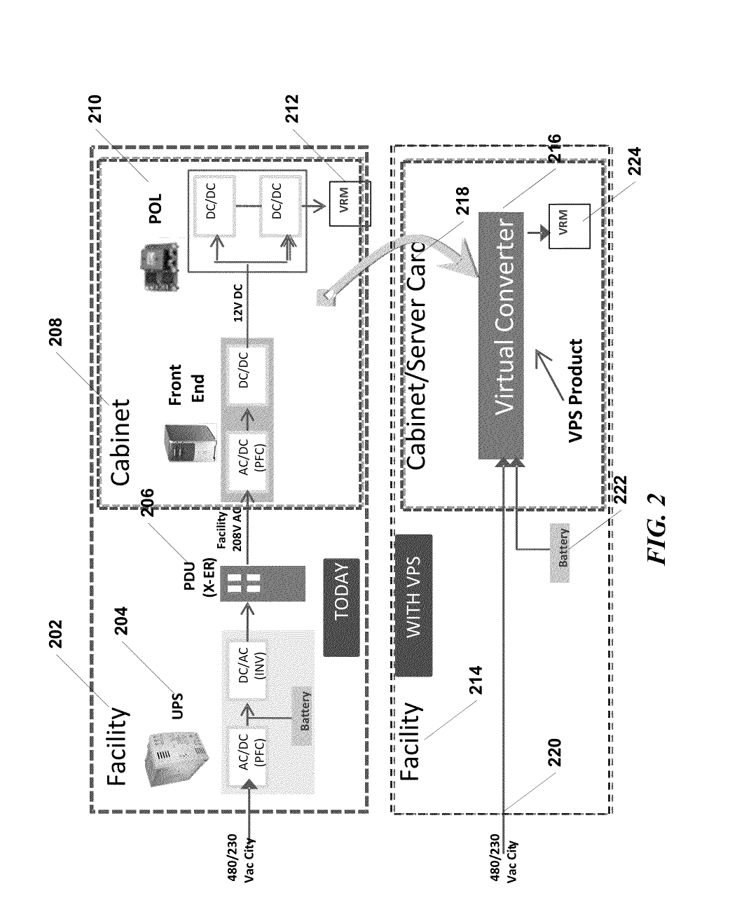

According to one or more embodiments of the present disclosure, FIG. 2 discloses a lower diagram of a facility (214) which is a power consuming location that implements a virtual converter (216), also known as a virtual power apparatus (VPA), according to one or more embodiments of the present disclosure. Specifically, the VPA (216) is located in a cabinet or server card (218) and receives the electrical power signal from the utility lines (220) or from some other source such as a battery (222). The VPA (216) then routes and alters, or shapes, the power signal according to the provided instructions from the software layer which may be provided in an image package. The VPA (216) routes the power signal to at least one VRM (224) found within the cabinet or server card (218). The VPA (216) is able to provide the functionality of a UPS (204), a PDU (206) and a POL (210), which are no longer present in this particular implementation. Further, the VPA (216) can receive an image and change the provided power signal such that a different routing or power signature is provided. Specifically for example, if a different voltage or a different VRM (224) is required, the VPA (216) can receive instructions which can be implemented on the power device within the VPA (216) using power commands which allow for the reconfigurable properties of the VPA (216).

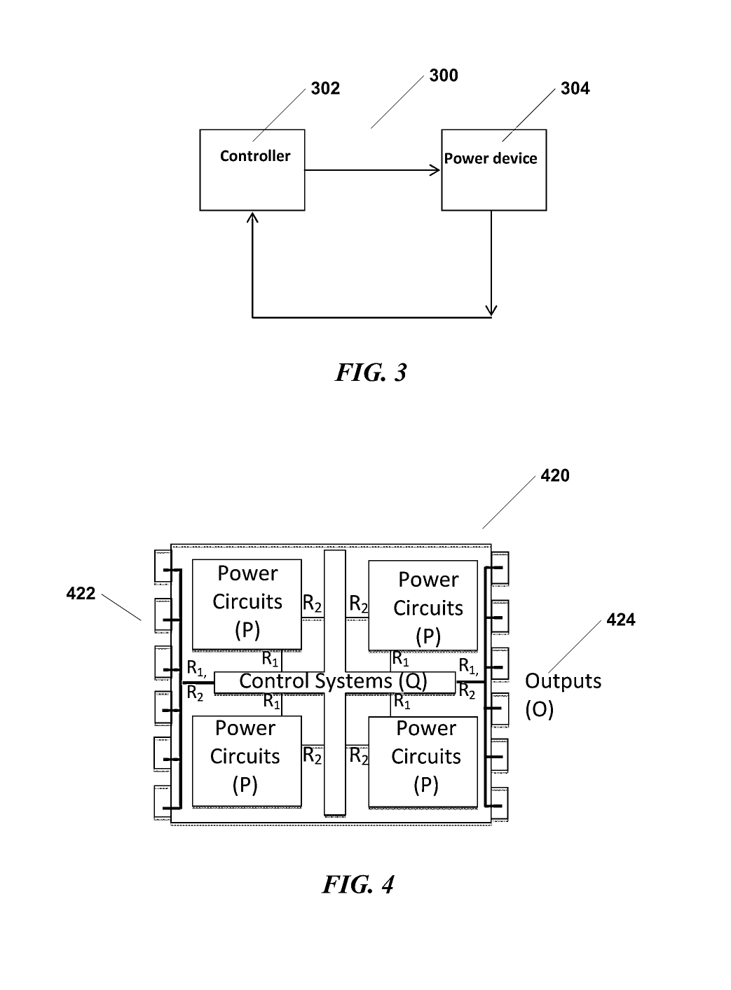

FIG. 3 is a block diagram of a virtual power apparatus (VPA) (300) according to one or more embodiments of the present disclosure. The VPA (300) includes a controller (302) and a power device (304). The controller (302) may also be called a control system and may be a field-programmable gate array (FPGA) or some other known processing core. The controller (302) may provide the functions of decision making, control, direction, feedback acknowledgement, system directory and status information processing, sensory data processing, and other such functionalities. The power device (304) can provide the functions of implementing the actual direction of the power signal through the VPA (300) from selected inputs to selected outputs while also reporting such routing implementation. Additionally, the power device (304) can provide the ability to shape or alter the power signal's frequency, current, voltage, and other similar properties based on the received commands from the controller (302) as well as receiving feedback and sensory data and transmitting it for processing by the controller (302).

FIG. 4 is a virtual power apparatus chassis (420) according to one or more embodiments of the present disclosure. Specifically, the VPA chassis (420) includes a plurality of power electronics, for example, the power circuits (P), which are also known as power devices, are provided such that there is a plurality within the overall VPA (420). As shown, there are four power circuits (P) in this embodiment. According to other embodiments, there may be more or less power devices included in a single VPA and it is also possible that the power devices contained within a VPA chassis are either all identical, or they could be completely different implementations that each provide different functionality, or a combination thereof. Additionally, the VPA chassis includes the control systems (Q) which are communicatively connected with digital or analog communication paths (R₁, R₂) to the power circuits (P). The control systems (Q) and the power electronic circuits (P) can each and together be organized physically in multiple topographies. The inputs (422) and the outputs (424) can each sustain a power signal of a wide range of voltages, for example, according to one or more embodiments, the inputs (422) and outputs (424) fall within a range of 1-480V.

Additionally, according to one or more embodiments, the input (422) and output (424) ports can be fixed-function or can be convertible from one type to the other. Further, although six of each input and output ports are shown in this embodiments, one VPA can carry any number of ports. Thus the VPA can have any rated capacity, depending on how many power circuits are packed in a device. According to another embodiment, by varying the power provided every microsecond or lower at each port, each output port can deliver any desired power profile, functioning for that moment as a power device designed to perform a given output from a given set of inputs. Further, by varying the power drawn every microsecond or lower, the power utilization from multiple inputs can be precisely controlled. Further, according to an embodiment of the present disclosure, the inputs and outputs may be variable in number and dynamically assigned by the control systems, also known as the power system controller, and the inputs and output ports can be internet addressable by implementing unique resource identifiers (URI).

According to one or more embodiments of the present disclosure, the power circuits (P) can convert, split, or aggregate power (AC-AC, AC-DC, DC-DC) to provide the desired power conversion or routing functions necessary. There can also be any number of power circuits (P) packaged in a VPA. According to an embodiment of the present disclosure, the power circuits can be developed using Multiple Bandgap Semiconductors, in addition to other semiconductor devices as well.

According to one or more embodiments of the present disclosure, the control systems (Q) are the controls necessary to operate the power circuits and can be in the form of analog and digital electronics. According to an embodiment, many of the digital control electronics and the analog to digital interfaces are provided in the form of software computed logic controls through micro controllers or FPGA devices. These control systems may use third party controls systems such as National Semiconductor drivers.

According to one or more embodiments of the present disclosure, the VPA can also include one or more sensors that measure physical quantities such as current, voltage, frequency, temperature, mechanical stress, and other such properties as well as measuring control signals. These sensors can provide the measured quantities and be controlled by the control systems/power system controller. Further, according to other embodiments, the sensors may be native sensors that automatically receive sensor data from power electronics or other portions as necessary. The data from the sensors can be obtained automatically or when asked for by the local logic or a power system controller of another communicatively connected VPA.

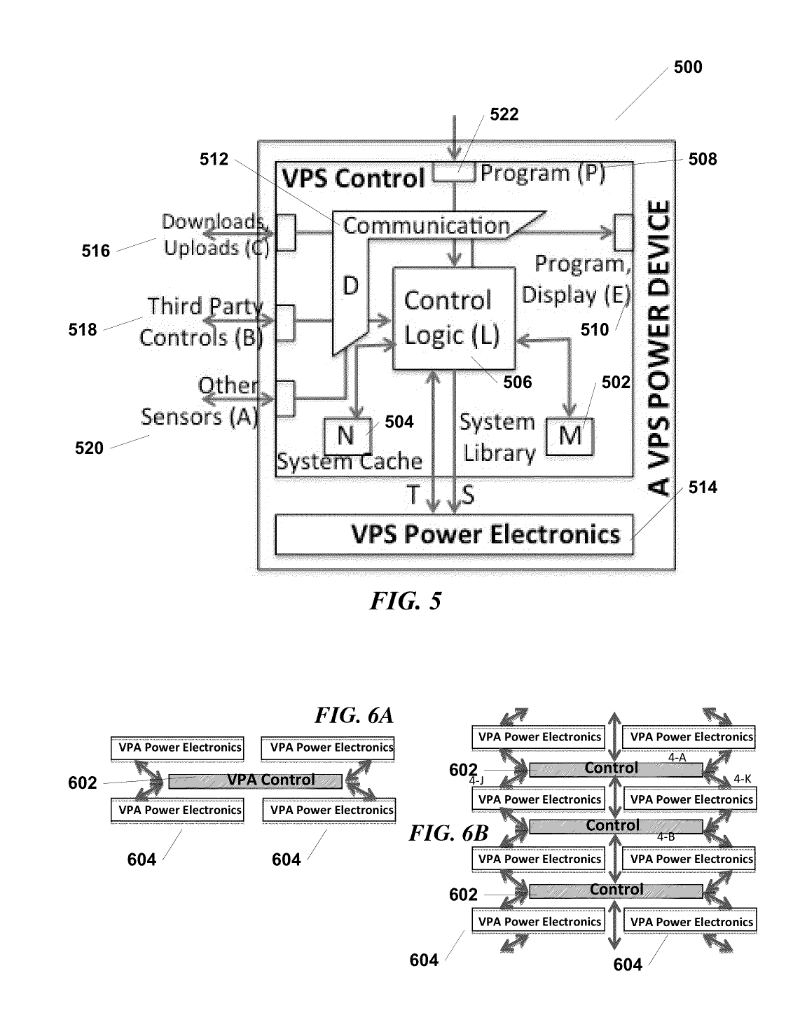

FIG. 5 is a diagram of a virtual power apparatus (500) (also known as and labeled as a VPS power device) with control logic (also known as and labeled as VPS control) according to one or more embodiments of the present disclosure. In this depiction of a VPA, the VPA is provided with a system library (502), a system cache (504), the control logic (506), a program (508), a display (510), communication (512), and power electronics (514) all communicatively connected to each other using digital or analog connections. Further, according to an embodiment, the VPA (500) contains, stores, receives, and sends program data including, but not limited to, a program from off the VPA (500) or a program stored in either the system cache (504) or system library (502). Additionally, the VPA can have other data such as downloads and uploads (516) acquired through a port as well as third party controls (518) or other sensor data (520). According to an embodiment, all these data types and inputs coming from off the VPA can stored within the system library (502) or system cache (504). Thus, the system library can hold relevant system data and programs of the VPA devices in a location as well as a source and load systems that they are connected to. The system cache can therefore be used more to hold hot programs and data required to be accessed or used more often or have quicker usage requirements. According to an embodiment, the program (508) may be programmed instructions that may have data and be done in JSON, XML, or other such protocols and used for display or by another VPA device or system.

According to one or more embodiments of the present disclosure, this data can contain the instructions, or an image that comprises a set of instructions, that set out an electric power solution to be implemented. For example, within the system cache or library, or incoming on one of the ports, may be a set of instructions that reprocessed by the control logic which then produces commands for controlling and guiding the power electronics which route and alter the power signal appropriately as designated by the provided electric power solution contained in the image or made up by the set of instructions. Further, the system library or cache may contain information used by the control logic, power system controller, during the processing of the instructions for commanding the power electronics appropriately. Further, the other data may also be used as called for in the image for implementing the described electric power solution.

For example, according to an embodiment of the present disclosure, the control logic (L) can send control signals (S) to the power electronic layer (514) based on sensory feedback from the other sensors (A) (520), third party controls (B) (518) that can be from other instances of this embodiment or other devices entirely, or download/uploads (C) (516). Further, the control logic (L) (506) may be based on the programs stored in the system library (M) (502) or can be based on real time instructions from a program (P) (508) arriving on a port (522). Additionally, according to an embodiment, the control logic (L) (506) has a security layer that ensures that received instructions or downloaded software is authentic and not compromised. Further the communication layer (D) (512) can also have its own security system. According to another embodiment, the control logic (L) (506) can directly operate multiple power electronics circuits both within the current VPA, or power electronics located in other VPAs. Further, the control logic (L) (506) can also operate as a hot stand-by to one or more VPA control logic systems in a facility.

According to one or more embodiments of the present disclosure the display is directly integrated with the VPA. In other embodiments the display is external to the VPA. In either case the display may be customized specifically for use with a VPA or it may be a general purpose display such as a tablet, computer, or cell phone.

FIGS. 6A and 6B are diagrams showing the communicative connection between power controllers and power devices according to one or more embodiments of the present disclosure. For example, as shown in FIG. 6A, a VPA control (602), also known as a power system controller, control logic, or control system, can control a plurality of VPA power electronics (604), which are also known as power devices. The number of circuits controlled depends upon the need, the complexity and size of the power electronics circuits as well as the complexity of the VPA control system used.

Further, according to another embodiment of the present disclosure, as shown in FIG. 6B, multiple VPA controls (602) can collaborate amongst themselves when controlling and managing a plurality of power electronics (604). The VPA controls (602) can therefore decide how and which VPA controls will handle each of the power electronics based on the instructions provided to the VPA controls which provides a programmable, flexible, and scalable power distribution system. Thus, VPAs can consolidate multiple functions of power conversion, conditioning, supply control and Power Factor correction, into a programmable multi-purpose digital power network device.

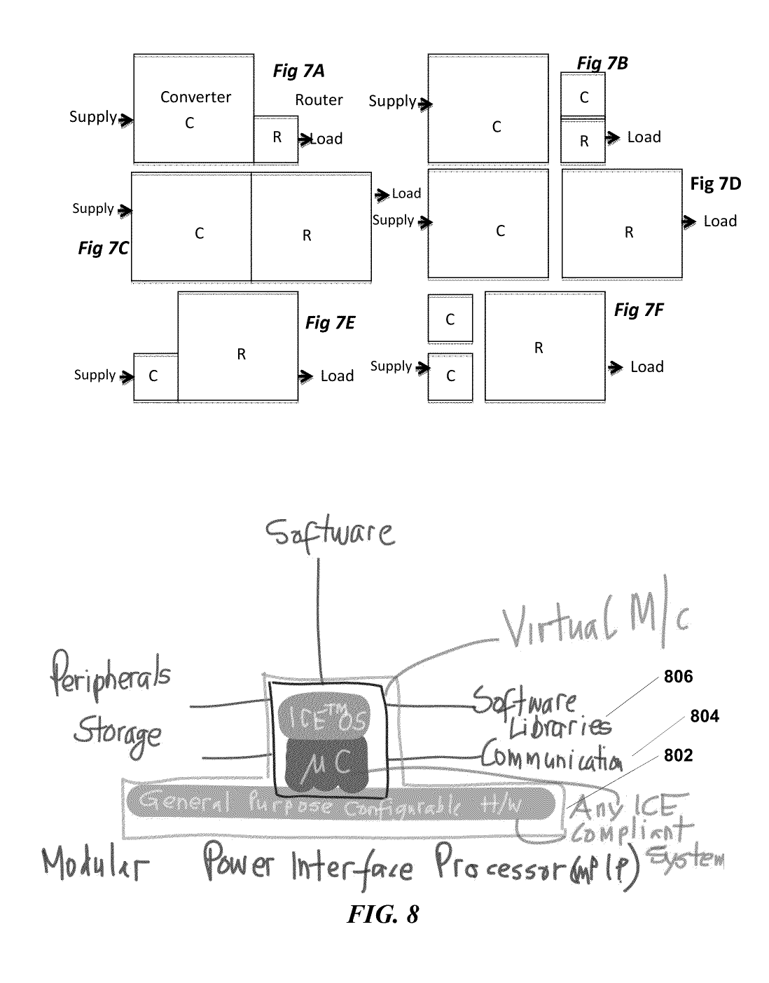

FIGS. 7A-7F are functional diagrams that are representative of converting and routing in accordance with a virtual power apparatus according to one or more embodiments of the present disclosure. FIG. 7A discloses a VPA that is provided electricity, also known as a power signal, from a supply. The VPA then takes that power signal and does a comparatively large amount of converting (C), or altering/shaping, to the power signal with a smaller amount of routing (R) of that power signal which is shown by the relative size of the functional blocks. This functional design would be implemented, for example, in a source and load scenario similar to a basic power supply where most of the desired implementation required is taking the source power and conditioning it such that it is of the proper voltage, current, and frequency needed for a source device connected.

FIG. 7B discloses a scenario where a first VPA implements only converting (C) on the power signal received from a supply, followed by another VPA that does some further converting (C) as well as some routing (R) of the power signal which is provided to the desired load. FIG. 7C discloses a single VPA that does both a large amount of converting (C) and routing (R). FIG. 7D discloses two VPAs, the first of which only does a large amount of converting (C) while the second VPA does all of the routing (R). FIG. 7E shows a scenario where a single VPA does a small amount of converting (C) while implementing a large amount of routing (R) of the power signal. Finally, FIG. 7F discloses three VPAs where the first two do some converting (C) while the third does a large amount of routing (R) of the power signal to the desired load.

According to one or more embodiments of the present invention, the supply may be a single power source, or it may also be a plurality of different power sources which provide electricity with different power characteristics. Similarly the load may be a single load, or it may be a plurality of loads, some of which require the same power signal, others of which may require a power signal with different power characteristics. Further, it is important to note that a single VPA, or group of VPAs, can be programmed to provide, under the desired conditions of one of the FIGS. 7A-7E, and be switched instantly to provide under another scenario or combination thereof upon receiving new instructions or images to do so.

FIG. 8 is a diagram depicting hardware and associated layers of software for controlling the hardware according to one or more embodiments of the present disclosure. As shown, a general purpose configurable hardware (802), or VPA, is operatively designed to accept communications (804) such as specific hardware commands or primitive switch commands. A software layer above that exists software libraries (806) which contain sets of instructions that include hardware and primitive switch commands arranged in such a manner that provide higher level implementations of desired power converting and routing. Further, sets of instructions can be arranged to provide images of specific electric power solutions. For example, an image of a power supply for a specific type server rack could be created which contains images for each specific server blade provided within that rack, each of which would contain the necessary instructions for providing the correct power signals to operate each part of the blades and rack as a whole. Further, the image could also contain the necessary instructions to handle a plurality of different source scenarios where the sources of electricity are not only variant but also variable.

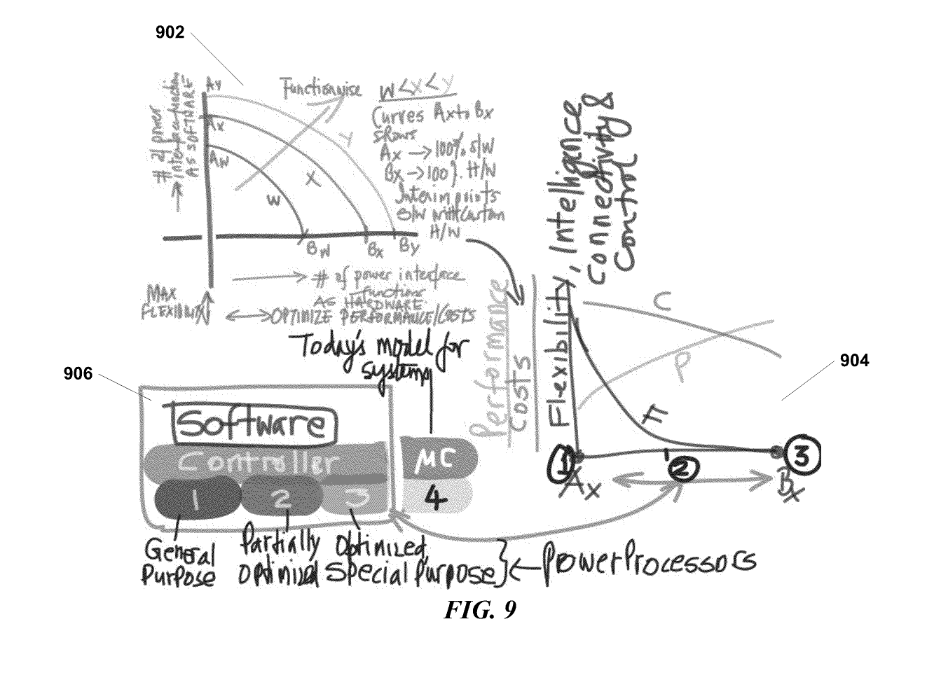

FIG. 9 is a plotting of hardware versus software implementation of a virtual power apparatus according to one or more embodiments of the present disclosure. The graph in the upper left (902) depicts a spectrum of possible implementations with the amount of functionality implemented purely in hardware on the X axis and the amount implemented in software on the Y axis. The curves from Y to X axis are suggestive of the same logical and actual outcomes but implemented in different ways. Further, the graph on the middle right (904) shows that as one moves from Bx (all hardware) to Ax (all software) the flexibility increases dramatically, the cost tends to increase, while the performance tends to decrease. Thus one can appreciate that the spectrum shows a plurality of options that provide varied results thus providing a large number of options to achieve the desired results while still allowing for software images and instructions to control the different VPA hardware implementations.

Further, according to one or more embodiments of the present disclosure, the diagram in the lower left (906) shows that today devices are implemented with different mixes of hardware hardwired functionality and programmed functionality. This is shown by the item labeled “4” in this diagram. The difference between today's implementation and one or more embodiments of the present disclosure is that today the code that runs on the micro-controller is unique to that specific product. If you have another product at a different point on the spectrum you start all over with the software. According to one or more embodiments of the present invention, the same software works with implementations at different points on the HW/SW spectrum, as shown and suggested by “1” and “2” and “3”.

According to one or more embodiments of the present disclosure, some possible implementations of, or realizations of, the processing capability that can be used in connection with the electric power solution implementing software can include processing devices ranging from Intel processors to ARM processors to FPGAs to PCs, such as Windows, Linux, or Mac based-systems, to virtualized devices in a cloud computing environment to any mix of all of these.

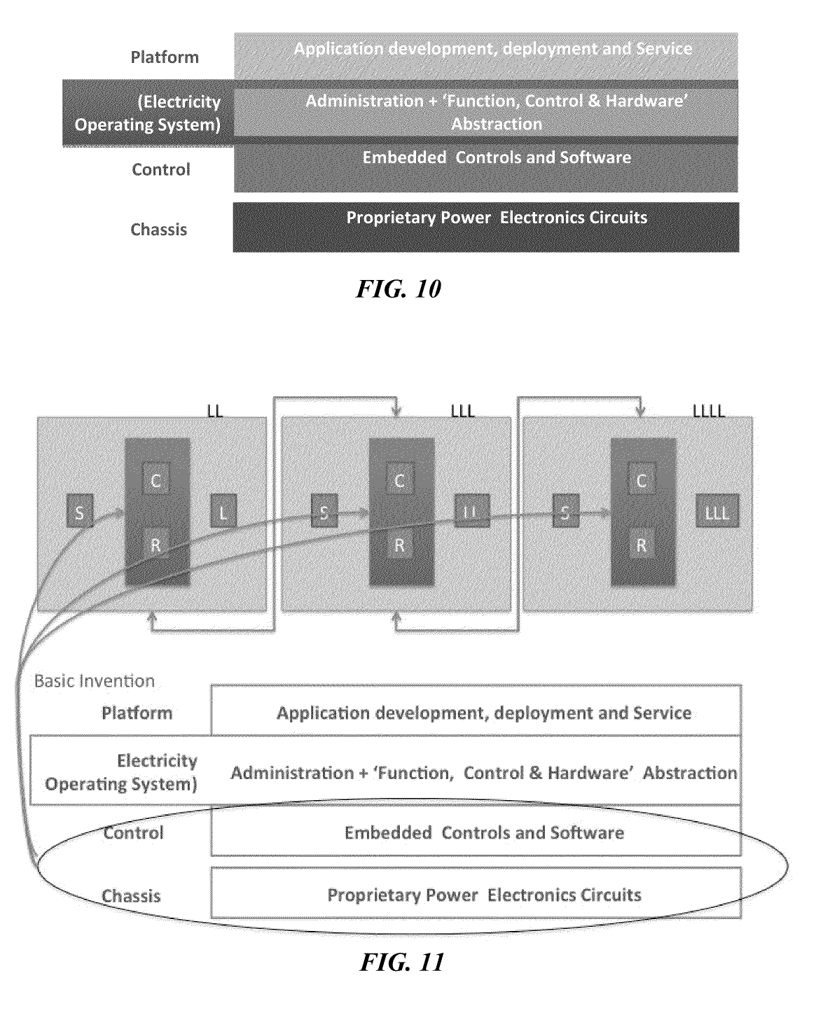

FIG. 10 is a depiction of software layers for a virtual power apparatus according to one or more embodiments of the present disclosure. At the most basic layer of programming there can be the basic commands that are used by a power system controller to particularly guide and control a power device during the altering and routing of a power signal. Further complexity exists when these commands are coupled into more complex instructions which can be processed by and given the power system controller of a VPA to implement desired actions. With such instructions, another layer of abstraction exists which allows for a collection of instructions to be grouped such that an image of a specific electric power solution can be created and packaged. Having these images of power solutions, such as power supplies or power requirements of specific processor, integrated circuit, motherboard, server blade, server rack, data center, or any other power consuming apparatus allows for another layer of abstraction. Particularly application development and deployment of services that take into account a plurality of different factors. For example, according to one embodiment, one application would be an application that contains the images for all the power loads in an office such as the computer station, printers, faxes, copiers, refrigerator, microwave, and so on. With these images, a “run office” application could be created that would turn on and off all the office equipment at desired times. Some considerations that could be taken into account include, but are not limited to, the efficiency due to the time of day or the particular objects usage criteria, as well as other considerations such as energy costs and other power grid information and metrics which could be taken into account to develop complex application level power control of not only an office but larger portions of entire power grid networks. Further, to simplify the implementation of this range of applications, some embodiments of this disclosure provide application development, testing, and deployment tools.

FIG. 11 is a diagram of a nested loop of virtual power apparatus according to one or more embodiments of the present disclosure. Specifically, this figure shows that a system can include a plurality of VPAs (LL, LLL, and LLLL) each of which can communicate with and control the successive VPA in the chain. For example, a specific load could be applied with a set of different and specific instructions for each VPA at each different layer. Further if that load is incident only on a first VPA, that VPA can apply the routed and altered power signal load to the following VPA with the instructions for the successive VPA to follow thereby providing an exchange of power between any two peers or successive VPAs in the chain.

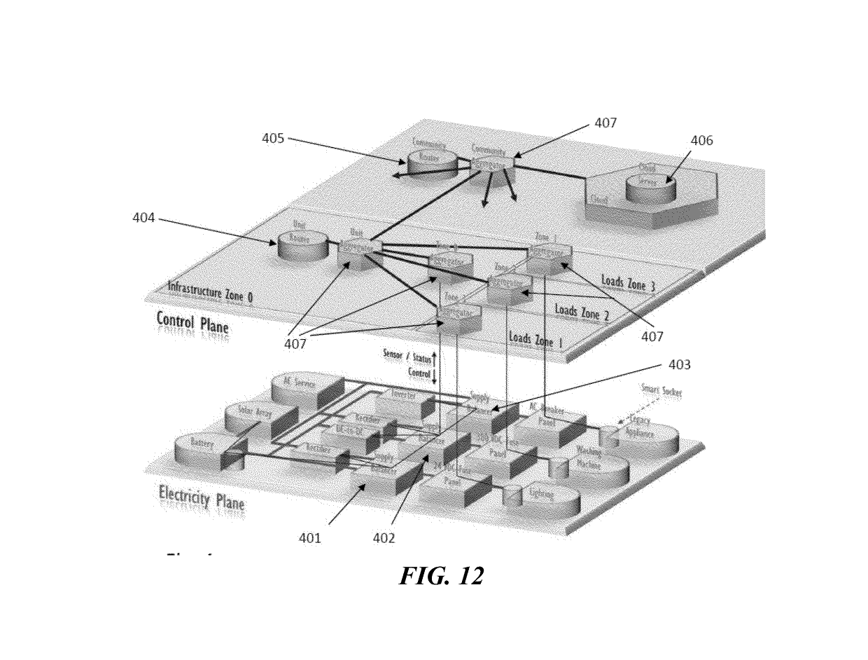

FIG. 12 is a diagram of a control plane and an associated electric plane according to one or more embodiments of the present disclosure. For purposes of description, it is useful to consider planes, levels, and layers. A plane contains all flows of a particular type. Three types of planes in our invention are utility planes, a control plane, and a business application plane. Different embodiments may implement different planes.

An exemplary utility plane is an electrical energy plane. At the level of a single family dwelling, the electrical energy plane may contain sources (mains service connection, solar energy panel), storage (battery), sinks (appliances), wiring, protection and distribution equipment (circuit breaker panel or fuse box), other infrastructure equipment. The other infrastructure equipment may include conversion devices (rectifier, inverter), switching equipment (source-side or sinkside), sensing points, and control points. Every element in the electrical energy plane is in the path of an electrical energy flow.

Other utility planes are similar, for example for thermal “heat” energy, thermal “cold” energy, natural gas, compressed air, gray water, or other utilities. At the level of a single family dwelling, a thermal “cold” energy plane may include a source (a community chilling line service connection, or a local refrigerator), a sink (an HVAC heat exchanger for forced-air air-conditioning, a freezer, or a refrigerator), a cold coolant supply line, a spent coolant return line, sensing points (temperature sensor), and control points (valve actuators), and other equipment.

In order to implement energy efficient features, an embodiment of our invention will implement a control plane. Typically a control plane includes a controller, a control point, a sensor point, a server, a communication network, and an external interface—and often more than one each of some of these elements. A controller receives input from sensor point(s) and/or the external interface, executes a control algorithm, and provides output to control point(s). The sensor points may exist integrated with control point(s), as separate sensor points, or integrated into other equipment. The external interface may be a human interface, such as a control panel, touch screen, or graphical user interface (GUI). Alternatively, the external interface may be a hardware or software interface for automated command and control, such as from a higher level control system. A control point typically controls a flow of a utility in a utility plane. As an example, a source balancer in an electrical energy plane may select between AC and DC sources (if both are available) to power an in-home electrical distribution network. In mid-afternoon, when electricity rates are high and sunlight is plentiful, the source balancer may be controlled to draw solar energy for domestic use; in the evening electrical energy may be drawn from battery storage, and later at night electrical energy may be drawn from a mains service connection. Another example is a valve actuator on a freezer, which is a control point in a thermal “cold” energy plane. The actuator may open and close an associated valve according to the freezer temperature and coolant availability. These two examples are source-side and sink-side control points respectively.

The controller, sensor point, and control point are the only essential elements of a control plane. In a reductionist example, the controller and control point may be integrated together with a sensor point and hard-coded with an immutable control algorithm. Then, no external sensor, communication network, server, or external interface is required. For example, a freezer coolant valve could be fixedly configured to regulate the freezer temperature to 0° F. Or an electrical source balancer could be fixedly configured to draw solar energy as long as it is available, and switch to mains service otherwise. However, such reductionist examples do not fully draw on the capabilities inherent in our invention.

A server in a control plane can perform a range of useful functions. One function is to update system configuration information to daughter nodes (such as controllers and control point), for example when equipment is added, removed, or changed. Another function is to host program updates for daughter nodes as and when such updates become available. In some embodiments, updates can be notified (pushed) to daughter nodes. In some embodiments, updates can be polled by the daughter nodes. Push notification is preferred. A third function for a server in a control plane is to log performance data for external access. Logged performance data may include some sensor data in some embodiments. Because sensor data may become quite voluminous, inclusion of sensor data may be selectively enabled. Likewise, logged performance data may also be selectively configurable in some embodiments. Performance data may include indicators of system health.

Server functions can be executed on a single server computer, or can be distributed among multiple server computers. Embodiments having multiple server computers may distribute functions among server computers differently. Some embodiments may split functionality by server function: for example, a first server computer may be responsible for program and configuration updates, while a second server computer may be responsible for logging performance data, and a third server computer may act as a web server to external parties. Other embodiments may have redundant servers in different geographic locations. Still other embodiments may have one server computer to manage server storage and another server computer for interfaces to daughter nodes and a third computer as a web server for external parties. These strategies for distribution of workload are exemplary. Other strategies for distribution of workload and combinations thereof may also be used.

A communication network enables flow of sensor information from sensor points to controllers and servers, enables flow of control information from controllers to control points, and enables flow of program and configuration information from server(s) to controllers, control points, and sensor points. The communication network may use wireless or wired technology, or a combination of both. The communication network may use dedicated communication channels, or the communication network may be overlaid on existing communication channels such as domestic Wi-Fi, wired Ethernet on private dwelling scale, semi-private community scale, or public Internet scale, or a cellular communication network. The communication network may use shared or dedicated physical media, or a combination thereof. The communication network may include communication nodes having communication functions. Such nodes may act as relay between different levels of the communication network, as aggregation nodes, as protocol converters, and/or as slaves to a controller, control point, sensor point, or other equipment. A communication node may exist in stand-alone form, or may be integrated with other functions.

An exemplary communication network uses power distribution wiring for power line communication within a dwelling unit. This is a dedicated communication channel over a shared physical medium. Communication to/from nodes on a section of power distribution wiring is relayed by a communication node associated with a centrally located piece of equipment (such as a circuit breaker panel). This communication node acts as an aggregation node and protocol converter, and is connected upstream by dedicated Ethernet wiring to a central communication node in the dwelling unit. This communication node acts as a slave to a central controller for the dwelling unit. The central communication nodes are connected by a semi-private community Ethernet network to a community communication node that is slave to a community controller, and thence over public Internet to a server resident in the Internet cloud.

In some embodiments, some sensor points and control points may be battery-operated and not connected to any power distribution. These sensor points and control points may be connected to a communication node (for aggregation and/or protocol conversion) by dedicated wiring or by wireless communication, similar to the common usage of both in security systems today. Suitable wireless standards include X10, Wi-Fi, ZigBee, and Bluetooth. Such dedicated wiring or wireless communication may be used in some embodiments even for sensor points and control points that are connected to power distribution wiring.

An external interface in a control plane may be provided at the server, at a controller, at a communication node, at any other node in the control plane, or as a separate entity. An exemplary external interface at a server may be a web interface. An exemplary external interface at a controller may be a wired or wireless service port. A wired service port may follow RS-232, RS-485, USB, or some other standard. Suitable wireless standards include X10, Wi-Fi, ZigBee, and Bluetooth. An external interface as a separate entity may be provided as a fixed control panel, as a portable control panel on a wireless device, or as a software application (“app”) for a commodity computer, smart phone, tablet, or other networked computing device. This external interface may be implemented using a client-server architecture, with the external interface being the client, and another node (in some embodiments, a central controller for the dwelling unit) being the server.

An external interface provides system access to one or more of the parties associated with a system for utility distribution and management. Different external interfaces may provide different levels of access to different parties. The parties may include an occupant of a building or dwelling unit, an owner, a building manager, a provider of building management services, an installer, a system owner, a system manager, community operations staff, service personnel, a utility company, a regulatory agency, an appliance vendor, and an infrastructure equipment vendor.

FIG. 12 shows an exemplary embodiment of an electrical energy utility plane and a control plane for a dwelling unit. Supply balancer (403) allows AC electrical power for a legacy AC appliance to be selectively drawn from either AC service, or from local battery storage through an inverter. Supply balancer (402) allows 380 VDC electrical power for a DC washing machine appliance to be selectively drawn from local battery storage through a DC-to-DC upconverter, or from AC service through a rectifier. Supply balancer (401) allows 24 VDC electrical power for lighting to be drawn local battery storage, or from AC service through a rectifier.

In the control plane, unit router (404) incorporates control functions of an Intelligent Control Module (described further below) and routing functions of an Intelligent Routing Module (described further below). In other embodiments, the node (404) may incorporate only the Intelligent Control Module, while the routing functions may be integrated with the supply balancers (401) to (403). At higher levels of the control plane are community router (405) and cloud server (406). Zone, unit, and community aggregators (407) are communication nodes.

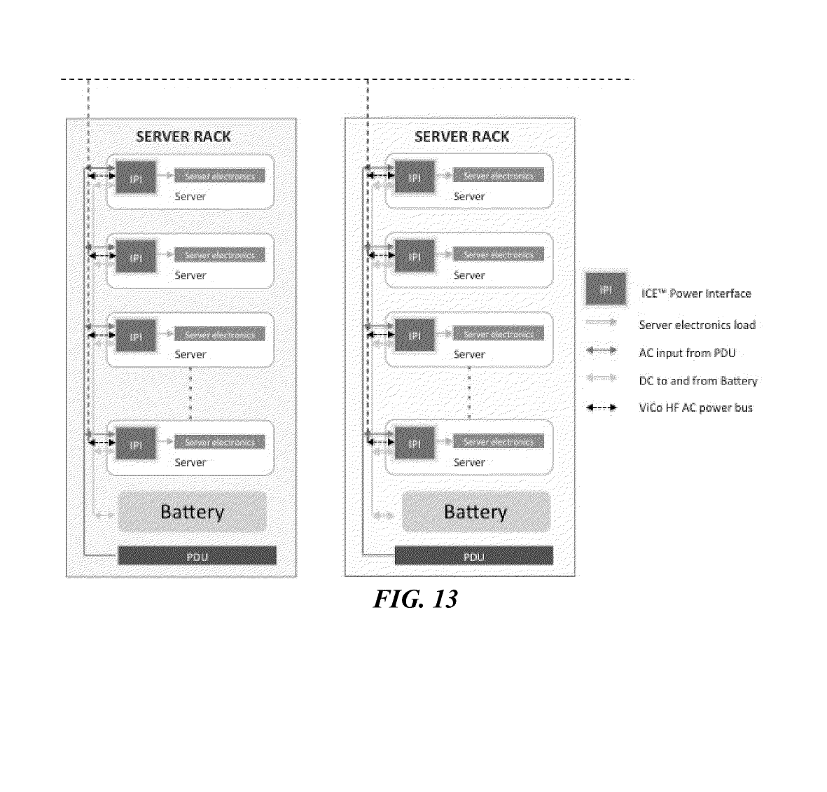

FIG. 13 is a diagram of server racks containing virtual power apparatus according to one or more embodiments of the present disclosure. In this embodiment it is shown that a VPA, or as depicted and labeled in the figure a Power interface ([P]) and also known as a virtual controller (ViC or ViCo), is placed within each server blade within a server rack such that each VPA controls the necessary power solution desired for each of the server electronics contained within each blade. The VPAs are able to not only control the power loads as determined by the instructions, images, or applications they receive or have already received, but can also be instructed to properly provide a power solution for the management of the supply of power to each. For example, each VPA is able to not only take power in, but if necessary they can transmit power between each other to help meet the required electric power solution while taking into account the multiple power sources already present such as a PDU, a battery, and any other source inputs to the system.

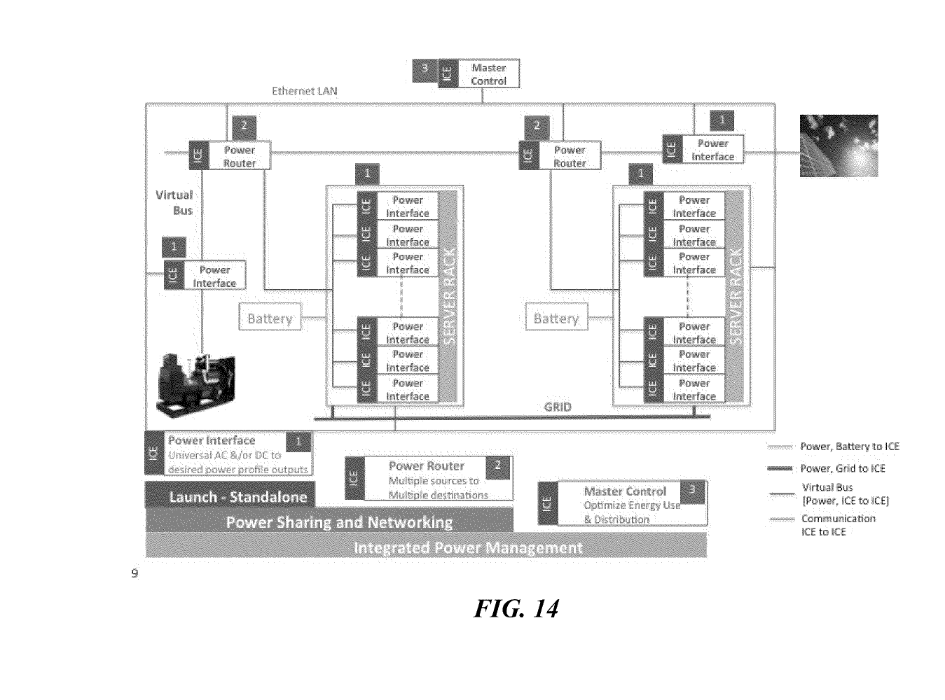

FIG. 14 is a diagram of server racks connected to and containing virtual power apparatus according to one or more embodiments of the present disclosure. In this figure a clear example of the nesting ability of a group of VPAs is shown. Particularly, a master type of VPA, labeled as a Master Control, is provided which implements the overall provided application which, as shown, may include optimizing energy use and distribution for an over all data center. Connected to this master type VPA (or ICE Master Control as depicted in the figure), are power router VPAs which control another layer of power distribution according the specific application and images and instructions provided to those VPAs. Then, similar to FIG. 13, within each server rack are power interface VPAs for each server blade. Further, other VPAs could be implemented at the electric power source points, such as solar panels and at generators, to implement additional layers of programmable power control.

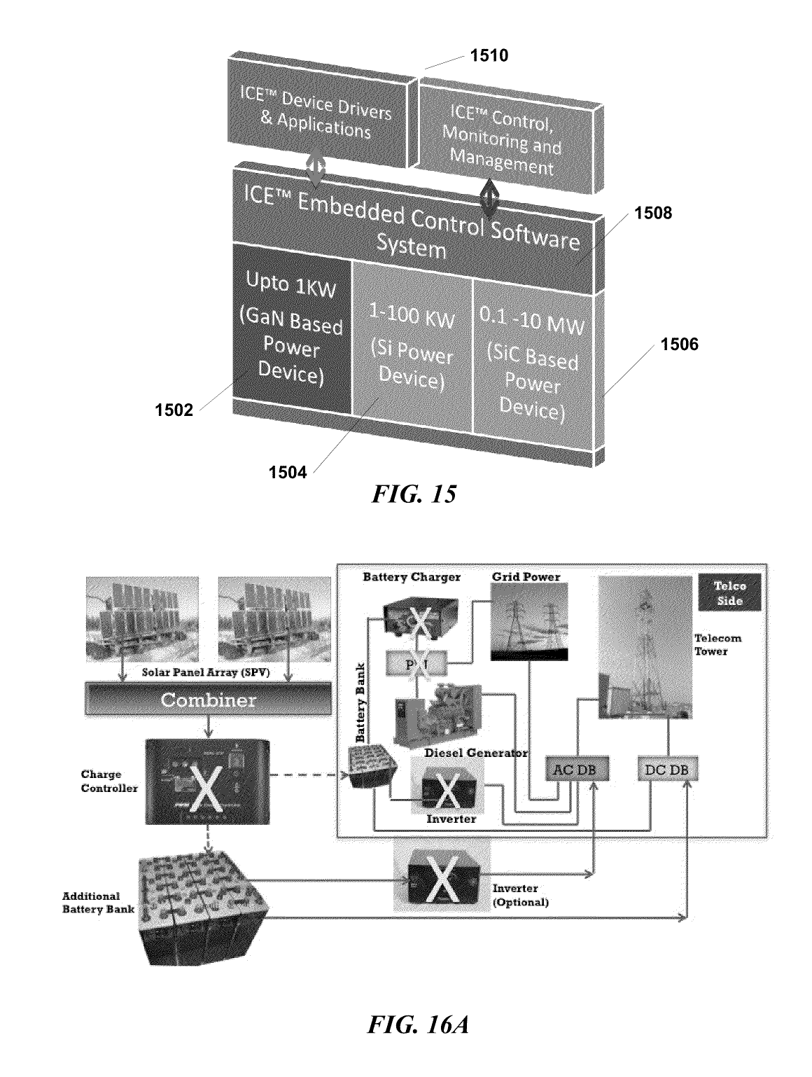

FIG. 15 is a block representation of the hardware and associated layers of software according to one or more embodiments of the present disclosure. In this figure is shown three different VPA implementations based on the kilowatts supported by each device's underling power device properties. Particularly, shown are three VPAs, a GaN based power device VPA (1502), a Si based power device VPA (1504), and a SiC based power device VPA (1506). Next is the software (1508) ability to programmably manage all three types of VPAs shown regardless of their underlying power device characteristics, while implanting the highest layers of abstraction as well (1510). An example of devices that can be implemented in software according to one or more embodiments of the present invention includes battery chargers, MPPT, and circuit switching while applications may include management, reporting, and billing as well as cloud management over the internet as well as local operator based workstation control.

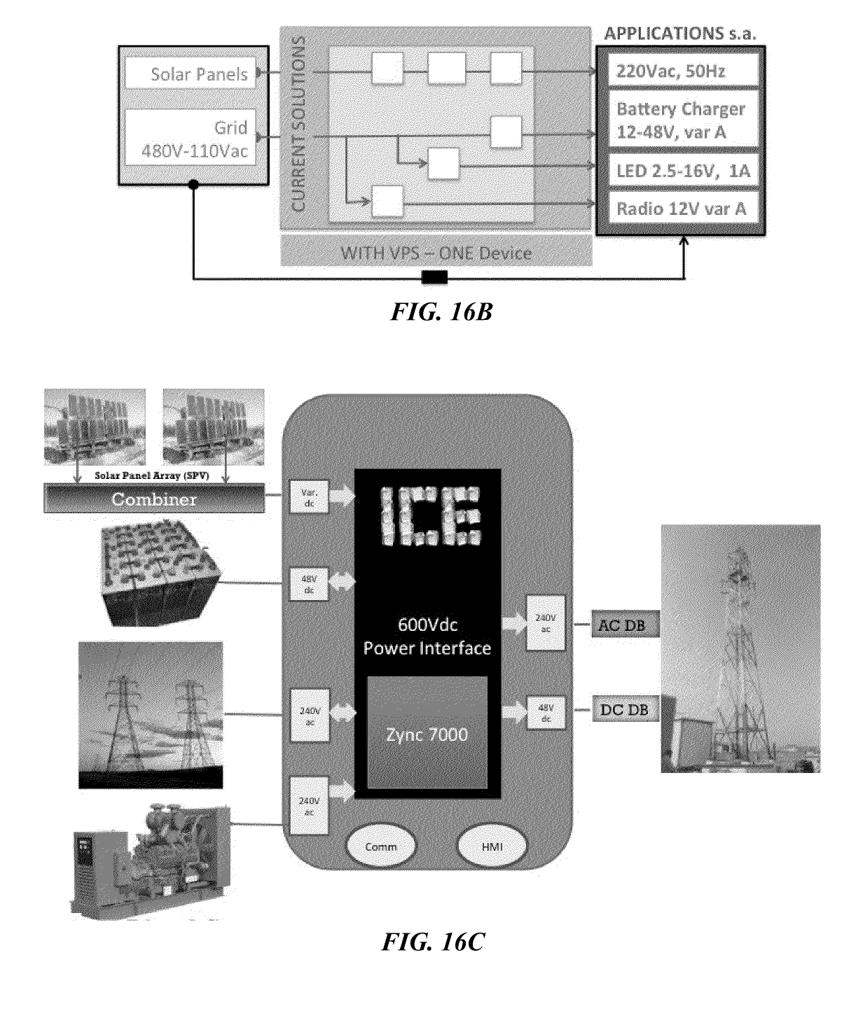

FIG. 16A is a depiction of a power grid arrangement showing the portions implemented by a virtual power apparatus according to one or more embodiments of the present disclosure. Particularly, this figure shows all the current power systems for conversion, switching, and routing that can be eliminated by a single VPA.

FIG. 16B is a diagram of a power grid arrangement implementing a virtual power apparatus according to one or more embodiments of the present disclosure. Specifically, this figure depicts a mobile tower application which is managed by a single VPA. By using a single VPA, it is clear that this single consolidated device provides an efficient, simple, smart, and small solution to implementing a desired electric power solution. Further, such an implementation provides fewer conversions, less clutter, easier management, easier upgrading, smart remote control, with the ability to automatically switch between power sources such as a battery, a solar array, or a power grid.

Similarly, FIG. 16C is a diagram of a power grid arrangement implementing a virtual power apparatus according to one or more embodiments of the present disclosure. Further, according to one or more embodiments of the present disclosure, the VPA can be implemented in a chassis which contains an interface that a user can have access to for adjusting the VPAs programming directly. For example, according to one or more embodiments, the VPA may contain a touch screen display integrated on the surface of the chassis through which a user can select an electric power solution which can be implemented by instructions and images already present on the VPA or can be retrieved from another VPA or cloud computing device with which the VPA is communicatively connected to.

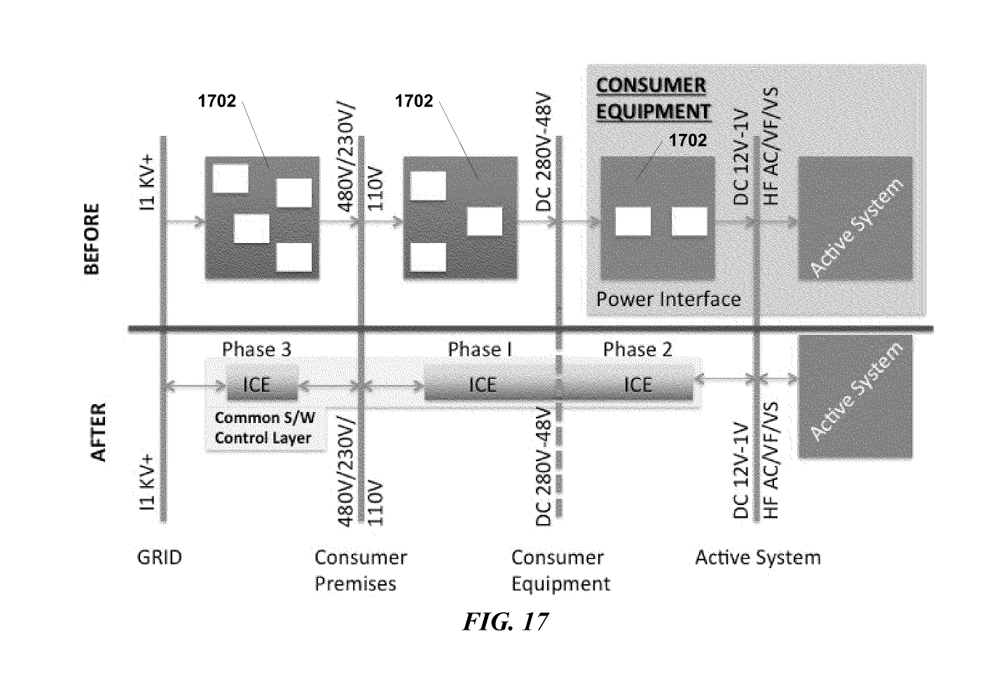

FIG. 17 is a diagram of a power grid arrangement implementing virtual power apparatus according to one or more embodiments of the present disclosure. This embodiment discloses an example of alternate power inputs and power load outputs and how the logical and physical arrangement would look for a system implementing VPAs as compared to an arrangement that exists today without VPAs. Specifically, before implementing any VPAs, a grid to consumer equipment system has a plurality of different power altering and routing devices (1702) from the power grid (GRID) to Consumer Premises as well as in the Consumer Premises and inside individual Consumer equipment (e.g. a 220 Vac to 380 Vdc inside a washer dryer; or a 12 Vdc to a 1.2 Vdc on a computer server electronics board). According to an embodiment of the present disclosure, with the implementation of VPAs (labeled as ICE in the figure) it can be seen that a single common system, a VPA, can substitute the plurality of systems currently used in the consumer premises, inside the equipment, as well as on the Grid side.

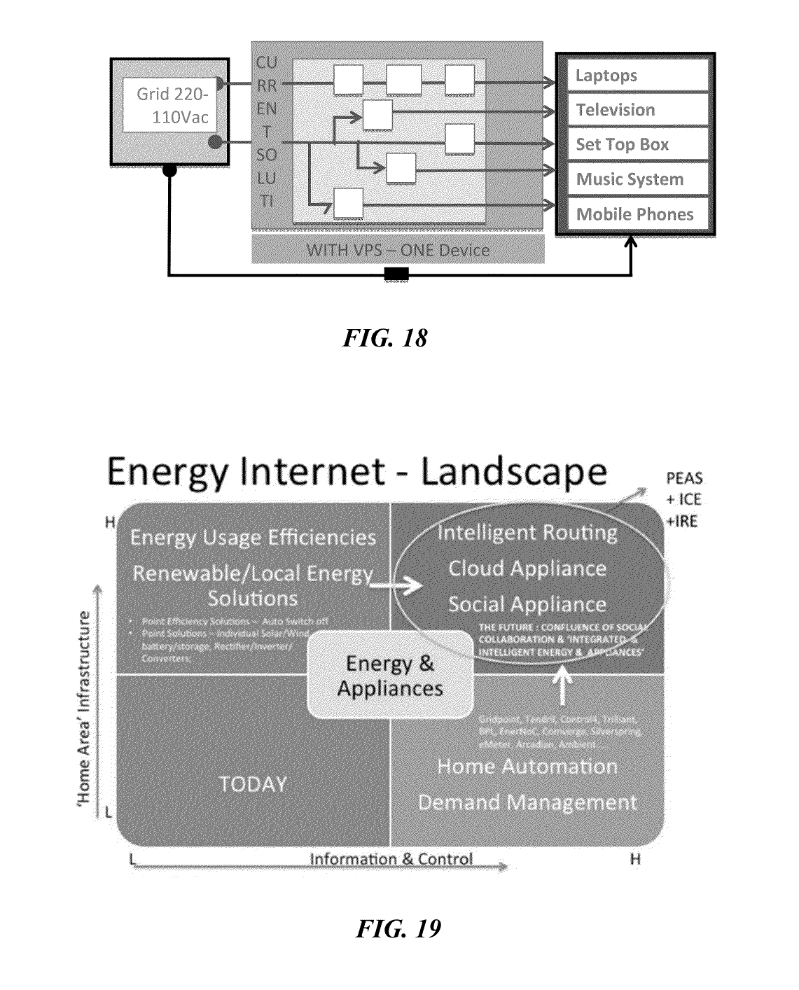

FIG. 18 is a diagram of a power grid arrangement implementing a virtual power apparatus according to one or more embodiments of the present disclosure. Particularly, this embodiment discloses a single power supply that is being routed through a VPA to a plurality of different devices and how the logical routing would look in the programmable sense within the VPA.

FIG. 19 is a landscape of information and control of power compared with power infrastructure according to one or more embodiments of the present disclosure.

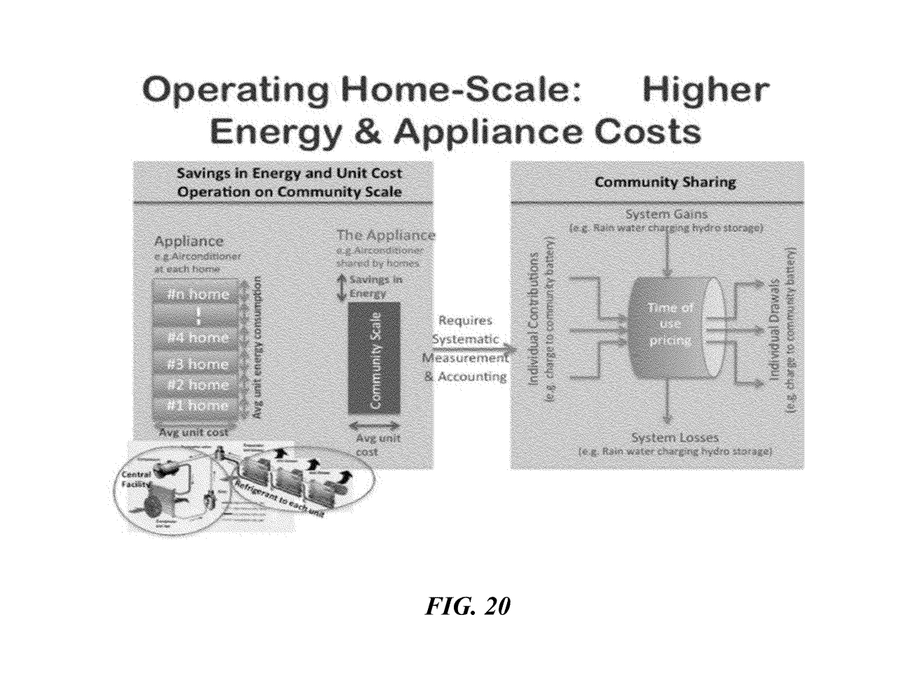

FIG. 20 is a diagram of power considerations to be used to control a virtual power apparatus according to one or more embodiments of the present disclosure. Particularly, this diagram shows other considerations that can be taken into account with developing and creating the applications to control the electrical power solution implemented on one or many VPAs.

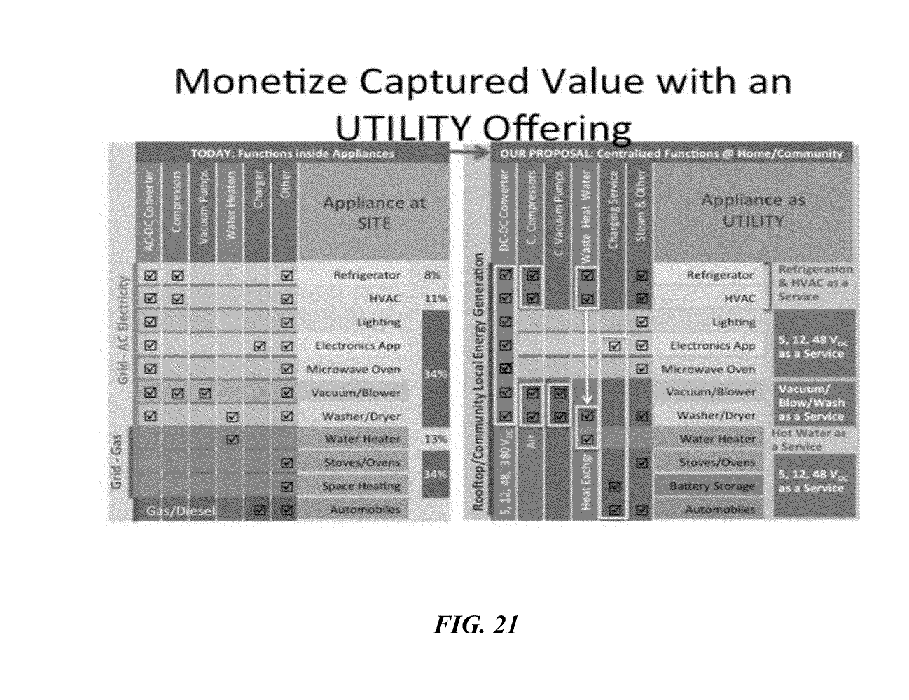

FIG. 21 is a diagram of power considerations to be used to control a virtual power apparatus according to one or more embodiments of the present disclosure. Specifically, this diagram shows other considerations that can be considered by the software when implementing power system functionality and control using one or more VPAs.

While the invention has been described with respect to a limited number of embodiments, those skilled in the art, having benefit of this disclosure, will appreciate that other embodiments can be devised which do not depart from the scope of the invention as disclosed herein. Accordingly, the scope of the invention should be limited only by the attached claims.

What is claimed is:

1. A system for at least one virtual power apparatus, comprising:
a first virtual power apparatus of the at least one virtual power apparatus, comprising:
a first port configured to receive a first power signal;
a second port configured to provide a second power signal; and
a power system controller communicatively connected to a power device and configured to:
receive an image of an electric power solution, wherein the image comprises instructions for deriving the second power signal by altering and routing the first power signal;
process the image by converting the image instructions into commands understandable by the power device;
send a command to the power device for realizing the image in the power device; and
receive a status from the power device,
wherein the power device is communicatively connected to the power system controller and configured to:
receive the command for realizing the image;
derive the second power signal by:
altering, based on the command, the first power signal; and
routing, based on the command, the first power signal;
provide the second power signal to the second port; and
send the status to the power system controller.

2. The system of claim 1, further comprising:
a second virtual power apparatus of the plurality of virtual power apparatus, wherein the second virtual power apparatus is communicatively connected to the first virtual power apparatus.

3. The system of claim 1, wherein the first port is reconfigured to provide the second power signal, wherein the second port is reconfigured to receive the first power signal, and wherein the power device provides the second power signal to the first port.

4. The system of claim 1, wherein the image of the electric power solution is received from a cloud computing device

5. The system of claim 1, wherein the image of the electric power solution is specific to a source of the first power signal, and wherein the image comprises instructions for reacting to information from a smart grid.

6. The system of claim 1, wherein the command further comprises at least one selected from a group of instructions consisting of:
a hardware command;
a primitive switch command;
an operating system library of commands;
a functional group of commands; and
an application.

7. The system of claim 1, wherein the electric power solution is at least one selected from a group consisting of a switch; a power supply; and a rectifier.

8. The system of claim 1, wherein altering comprises at least one selected from a group consisting of:
adjusting a voltage of the first power signal;
adjusting a current of the first power signal;
adjusting a frequency of the first power signal;
converting the first power signal from AC to AC;
converting the first power signal from AC to DC;
converting the first power signal from DC to AC;
converting the first power signal from DC to DC; and
delivering a power profile of the power signal.

9. The system of claim 1, wherein routing further comprises at least one selected from a group consisting of switching the power signal; multiplexing the power signal; and
de-multiplexing the power signal.

10. A method for a virtual power apparatus, comprising:
receiving, by a power system controller, an image of an electric power solution, wherein the image comprises instructions for altering and routing a first power signal for deriving a second power signal;
processing the image by converting the image instructions into commands understandable by a power device;
sending, by the power system controller and to the power device, a command for realizing the image in the power device; and
receiving, by the power system controller, a status from the power device.

11. The method of claim 10, wherein the command further comprises at least one selected from a group of instructions consisting of:
a hardware command;
a primitive switch command;
an operating system library of commands;
a functional group of commands; and
an application.

12. The method of claim 10, wherein the electric power solution is at least one selected from a group consisting of a switch; a power supply; and a rectifier.

13. The method of claim 10, wherein altering comprises at least one selected from a group consisting of:
adjusting a voltage of the first power signal;
adjusting a current of the first power signal;
adjusting a frequency of the first power signal;
converting the first power signal from AC to AC;
converting the first power signal from AC to DC;
converting the first power signal from DC to AC;
converting the first power signal from DC to DC; and
delivering a power profile of the power signal.

14. The method of claim 10, wherein routing further comprises at least one selected from a group consisting of switching the power signal; multiplexing the power signal; and
de-multiplexing the power signal.

15. The method of claim 10, wherein the image of the electric power solution is received from a cloud computing device.

16. The method of claim 10, wherein the image of the electric power solution is specific to a source of the first power signal, and wherein the image comprises instructions for reacting to information from a smart grid.

17. A virtual power apparatus comprising:
a first port configured to receive a first power signal;
a second port configured to provide a second power signal; and
a power device communicatively connected to a power system controller and comprising functionality to:
derive the second power signal from the first power signal; and
provide the second power signal to the second port,
wherein the power system controller is communicatively connected to the power device and configured to control the power device.

18. The virtual power apparatus of claim 17, wherein the first port is reconfigured to provide the second power signal, wherein the second port is reconfigured to receive the first power signal, and wherein the power device provides the second power signal to the first port.

19. A non-transitory computer-readable medium storing a plurality of instructions for a virtual power apparatus, the plurality of instructions comprising functionality to:
receive an image of an electric power solution, wherein the image comprises instructions for altering and routing a first power signal for deriving a second power signal;
process the image by converting the image instructions into commands understandable by a power device;
send a command for realizing the image in the power device; and
receive a status from the power device.
